(19) United States
(12) Patent Application Publication
(10) Pub. No.: US 2026/0356614 A1
(43) Pub. Date: Nov. 12, 2026

(54) METHOD AND DEVICE FOR TRANSPORTING VALUE DOCUMENTS

(71) Applicant: GIESECKE+DEVRIENT CURRENCY TECHNOLOGY GMBH, Munchen (DE)

(72) Inventors: Xaver THUM, Wolfratshausen (DE); Frank NEUDEL, Freising (DE); Michael FRESE, Neubiberg (DE)

(21) Appl. No.: 19/123,925

(22) PCT Filed: Oct. 26, 2023
(86) PCT No.: PCT/DE2023/100794

§ 371 Date: Apr. 24, 2025

(30) Foreign Application Priority Data
Oct. 28, 2022 (DE) 10 2022 128 670.3

(51) Int. Cl. B65H 7/14; B65H 5/06; G07D 11/16

(52) U.S. Cl. CPC B65H 7/14; B65H 5/062; G07D 11/16; B65H 2301/44318; B65H 2513/10; G07D 2211/00

(57) ABSTRACT

An apparatus and a method are for transporting documents of value, wherein the documents of value are transported individually one after the other along a transport path. Along the transport path of the documents of value there are arranged a preceding transport means, a speed adaptation device, and a following transport means. The speed adaptation device comprises at least one transport roller pair, by means of which the transport speed of the document of value is changed from the first transport speed of the preceding transport means to the second transport speed of the following transport means.

The invention relates to a method and an apparatus for transporting documents of value.

It is known to transport documents of value individually one after the other with the aid of transport means, such as, for example, by means of belts or rollers, between which the documents of value are clamped. The transport means may be arranged inside a document of value processing apparatus or outside document of value processing apparatuses. It may happen that the transport means run at different transport speeds for the documents of value. The difference in the transport speeds may be small, for example may occur only as a result of slightly different drives of the transport means. However, the difference may also be great and intentional, for example because the transport means belong to different devices or have different transport tasks. The following transport means arranged downstream may run more quickly or more slowly than the preceding transport means arranged upstream thereof.

At an abrupt transition from the preceding transport means to the following transport means, the documents of value can be subjected to considerable mechanical stress or can even be damaged. In the case of a following transport means that runs more slowly, the documents of value can be squeezed together, for example, and thus possibly concertinaed, and in the case of a following transport means that runs more quickly, the documents of value can be stretched, for example, and possibly torn.

Accordingly, an object of the invention is to provide a method and an apparatus with which the risk of damage to the documents of value at the transition between transport means that run at different speeds is reduced.

This object is achieved according to the invention by a method and an apparatus as claimed in the independent claims. Advantageous embodiments of the invention are subject matter of the dependent claims.

The invention proposes a transport device, which transports documents of value individually one after the other along a transport path and which comprises along the transport path at least one preceding transport means, which provides a first (e.g. constant) transport speed for the documents of value transported thereby, and -downstream of the preceding transport means-at least one following transport means, which provides a second (e.g. constant) transport speed for the documents of value transported thereby, said second transport speed being different from the first transport speed, in particular being lower or higher than the first transport speed.

The transport device comprises a speed adaptation device having at least one transport roller pair, which is arranged along the transport path between the preceding and the following transport means. The speed adaptation device is configured to change, in particular to increase or to reduce, a transport speed of a document of value transported at the first transport speed by means of the preceding transport means to the speed adaptation device from the first transport speed to the second transport speed of the following transport means with the aid of the at least one transport roller pair, in particular by changing or modulating the rotational speed of one or both of the transport rollers of the at least one transport roller pair.

By means of the speed adaptation device according to the invention having the transport roller pair, the documents of value can be accelerated or decelerated to a different transport speed with a low risk of damage. This is of great importance in the case of used documents of value, for example, but is also advantageous for other documents of value.

In particular, the preceding transport means is configured to transport the documents of value to the speed adaptation device. And the speed adaptation device is configured to bring the document of value from the first transport speed of the preceding transport means to the second transport speed of the following transport means with the aid of the at least one transport roller pair.

The speed adaptation device can be configured to convey or transfer the document of value to the following transport means at the second transport speed, for example at the end of the change of the transport speed or after the change of the transport speed. The following transport means is configured to transport the document of value further along the transport path after the speed adaptation device. In other words, the speed adaptation device is configured to adapt the transport speed of the documents of value to the different transport speeds of the two transport means.

Preferably, the speed adaptation device is configured to rotate one or both of the transport rollers of the at least one transport roller pair with a variable or with a modulated rotational speed. In particular, the rotational speed of the at least one transport roller pair is modulated such that the transport speed of the document of value is changed from the first transport speed to the second transport speed by the action of the at least one (preferably both) transport roller(s), rotating with a modulated rotational speed, of the transport roller pair.

Further transport elements, for example guide elements, freewheel rollers or the like, may also be situated along the transport path between the preceding transport means and the speed adaptation device and/or between the speed adaptation device and the following transport means.

One advantage of the speed adaptation device having at least one transport roller pair, for example compared to conveyor belts that are used to change the speed, is that the at least one transport roller pair has a smaller extent along the transport path. It is thus achieved that the speed adaptation can purposively be carried out for a single document of value, without further documents of value being engaged by the at least one transport roller pair. This permits an individual speed adaptation specifically for a single document of value.

A further advantage of the speed adaptation device having at least one transport roller pair, for example compared to conveyor belts that are guided via rollers and used for changing the speed, is that the transport rollers of the at least one transport roller pair have a lower inertial mass than conveyor belts that are guided via rollers. Therefore, the at least one transport roller pair can implement the dynamics of acceleration/deceleration with a lower inertia and thus more quickly.

In preferred exemplary embodiments, the direction of the second transport speed corresponds substantially to the direction of the first transport speed, that is to say the document of value is transported further after the speed adaptation device at least approximately in the same direction as it is transported to the speed adaptation device. For example, the preceding transport means, the speed adaptation device and the following transport means form a straight portion of the transport path of the documents of value.

The speed adaptation device comprises at least one rotatable transport roller pair, which is arranged along the transport path in the region of the transition between the preceding and the following transport means. The transport roller pair of the speed adaptation device comprises at least one upper transport roller arranged above the transport path of the documents of value, and at least one lower transport roller arranged beneath the transport path of the documents of value, the document of value being clamped between said transport rollers. The transport rollers can act mechanically on a document of value transported between them in order to accelerate/decelerate it. Each transport roller of the transport roller pair preferably has a uniform roller radius over its circumference.

The transport roller pair can be configured to clamp the document of value between the upper and lower transport rollers in order to transmit, preferably by frictional engagement, a force to the document of value, in particular a force for accelerating or decelerating the document of value. For example, the transport rollers of the transport roller pair are configured to accelerate/decelerate the document of value relative to a document of value (the next document of value immediately following said document of value along the transport path) that is being transported along the transport path, by mechanical action on the document of value. One or both of the transport rollers of the transport roller pair can be adapted to suction the document of value in order to transmit the force for acceleration/deceleration to the document of value.

Preferably, one or both of the transport rollers of the transport roller pair is/are configured to transport the documents of value by frictional engagement.

The speed adaptation device preferably comprises at least one transport roller drive for the at least one transport roller pair, and a control device for controlling the at least one transport roller drive. The control device is adapted in particular to drive the at least one transport roller pair by means of the at least one transport roller drive such that the at least one transport roller pair receives the document of value from the preceding transport means at the first transport speed, brings (accelerates/decelerates) the document of value to the second transport speed and conveys or transfers the document of value to the following transport means at the second transport speed.

The transport roller pair of the speed adaptation device can be driven by means of the at least one transport roller drive such that the path speed of the transport rollers is varied, for example periodically, between exactly or approximately the first transport speed and exactly or approximately the second transport speed of the documents of value.

The control device can be adapted to drive the at least one transport roller pair by means of the at least one transport roller drive such that the path speed or rotational speed of the transport rollers is modulated periodically, that is to say repeatedly. The transport speeds of multiple documents of value can thus be changed one after the other. Said documents of value can be accelerated or decelerated in the same way or in different ways.

The path speed of the transport rollers is preferably changed continuously or constantly (i.e. not abruptly) from the first transport speed to the second transport speed of the documents of value (continuously increased or continuously reduced) and then brought back to the first transport speed again (reduced or increased). Changing the transport speed continuously is particularly gentle on the documents of value and also on transport roller drives, since the mechanical stress on the transport roller drive is kept low.

The transport roller drive can be a modulatable rotary drive, for example a variable-speed motor. The control device can be adapted to control the at least one transport roller drive such that it rotates at least one, preferably both, of the transport rollers of the at least one transport roller pair with a modulated rotational speed. Thus, the upper and/or lower transport roller of the transport roller pair can be driven by means of the transport roller drive. This is because it may be sufficient for only one transport roller of the two transport rollers to be driven and for the other to be rotated concomitantly (through frictional engagement by the clamped document of value) when the document of value is being transported along by the opposite, driven transport roller. Preferably, however, both transport rollers are driven with the same (varying) rotational speed, wherein the upper transport roller and the lower transport roller are rotated in mutually opposite directions in order to transport the document of value along the transport path.

The control device of the speed adaptation device is adapted in particular to control the at least one transport roller drive of the at least one transport roller pair such that the transport speed of the document of value is changed from the first transport speed to the second transport speed by the modulated rotational speed of the at least one transport roller pair. The control device can modulate the rotational speed of the at least one transport roller pair, with the aid of the at least one transport roller drive of the at least one transport roller pair, such that the transport speed of the document of value is changed with the aid of the at least one transport roller pair, in particular by the modulated rotational speed of the at least one transport roller, from the first transport speed to the second transport speed.

The apparatus can comprise a plurality of the described speed adaptation devices, which may be identical or different and can be arranged, for example, one after the other, for example in order to compensate for greater differences in the transport speeds of the preceding and following transport means.

In order to prevent the documents of value from twisting as they are accelerated, at least one further upper transport roller can be arranged concentrically with the upper transport roller (e.g. on the same drive shaft) and laterally offset relative thereto, and/or at least one further lower transport roller can be arranged concentrically with the lower transport roller (e.g. on the same drive shaft) and laterally offset thereto. These form a laterally offset further transport roller pair, between which the documents of value are likewise clamped and which accelerate/decelerate the documents of value in the same way as the first-mentioned transport roller pair.

The transport device comprises along the transport path at least one preceding and at least one following transport means, each of which can comprise, for example, at least one transport belt and/or at least one transport roller and/or at least one transport roller pair or a combination thereof. For example, the preceding and/or the following transport means comprise/comprises mutually opposite transport belts (e.g. running on rollers), between which the documents of value are clamped as they are being transported. The preceding and/or following transport means can, however, also comprise one or more transport roller pair(s) having an upper and a lower transport roller, between which the document of value is clamped. The following transport means provides a higher or lower transport speed for the documents of value transported thereby than the preceding transport means. In particular, the preceding and/or the following transport means are/is configured to transport the documents of value by frictional engagement.

In particular, the document of value can be accelerated/decelerated from the first transport speed to the second transport speed by the rotation of the at least one transport roller pair of the speed adaptation device. For example, the at least one transport roller pair of the speed adaptation device can to this end impart a temporary acceleration pulse/deceleration pulse to each document of value that arrives at the transition between the preceding and the following transport means, in order to accelerate/decelerate said document of value from the speed of the preceding transport means to the speed of the following transport means. More gentle acceleration/deceleration of the documents of value is thus achieved than in the case of abrupt acceleration/deceleration by the following transport means alone, that is to say without the presence of a speed adaptation device in addition thereto.

Preferably, the speed adaptation device is configured to accelerate/decelerate a first document of value, in particular each first document of value, which is being transported along the transport path downstream of a second document of value immediately following said first document of value, relative to the second document of value. The distance between the first document of value and the second document of value can thus be increased/reduced.

In a first variant of the invention, the speed adaptation device is configured to accelerate the documents of value from the first transport speed to the (higher) second transport speed. By accelerating the documents of value, the speed adaptation device can achieve an increase in the distance between the successive documents of value. Compared to increasing the distance by slowing down the following document of value or by stop-and-go operation of the transport device, this acceleration has the advantage that the increase in the distance does not then have a retroactive braking effect on the upstream process, nor is a buffer store for the documents of value required therebetween.

In a second variant of the invention, the speed adaptation device is configured to decelerate the documents of value from the first transport speed to the (lower) second transport speed. By means of the deceleration, the speed adaptation device can achieve a reduction in the distance between the successive documents of value. By reducing the distance between the documents of value, it is possible to transport more documents of value along the transport path per unit length than is possible in the case of a greater distance. A portion of the transport path situated after the speed adaptation device, for example the portion of the following transport means, could thus be used as a buffer store for documents of value, that is to say for temporarily storing or at least for slowing down the documents of value, if this is required for a subsequent process.

Alternatively or in addition to the acceleration/deceleration, the speed adaptation device can also be adapted to adapt to one another the distances between the successive documents of value. It can thus be achieved that, after passing through the speed adaptation device, the leading edge distance of the successive documents of value is at least approximately equal for all or at least for a large number of successive documents of value. More uniform processing of the documents of value, for example a high stacking quality of a stack produced from these documents of value by a stacking wheel, can thus be achieved. This is because, if the leading edge distance of the successive documents of value is at least approximately equal, uniform transportation of the documents of value into the rotating stacking wheel is achieved, which improves the stacking quality.

By means of the speed adaptation device, different acceleration/deceleration of documents of value of different lengths can also be achieved in a simple manner. To this end, the intensity or duration of the acceleration is correspondingly adapted to the length of the document of value, for example such that the leading edge distances of the documents of value of different lengths are equal.

For the adaptation, the speed adaptation device, in particular the control device and the transport roller drive thereof, can be configured to control the intensity of the acceleration/deceleration of the first document of value individually, for example in dependence on the distance of the document of value from the next document of value and/or in dependence on the distance of the document of value from the preceding document of value. For example, the speed adaptation device accelerates the document of value more strongly if the distance thereof from the document of value following it is smaller than a lower limit distance, and/or less strongly if the distance thereof from the document of value following it is greater than an upper limit distance. This control of the speed adaptation device can be carried out on the basis of a sensor (e.g. light barrier(s)) located upstream of the speed adaptation device, said sensor measuring the distance between the successive documents of value. Advantageously, by accelerating/decelerating the documents of value individually, a more uniform distance between the documents of value can be achieved.

In order to individually accelerate one or more documents of value more strongly than others, the modulatable rotary drive can for a short time provide an even further increased/reduced transport speed for the document(s) of value in question than for the other documents of value. For an individually less strong acceleration/deceleration of one or more documents of value, a less strongly increased/reduced transport speed is correspondingly provided.

Preferably, the distance between the last point of engagement of the preceding transport means and the first (optionally only) point of engagement (clamping point) of the at least one transport roller pair of the speed adaptation device is smaller than the length of the documents of value, and/or the distance between the last (optionally only) point of engagement of the at least one transport roller pair and the first point of engagement of the following transport means is smaller than the length of the documents of value. The document of value is then simultaneously in engagement with the preceding transport means and in engagement with the (first) transport roller pair of the speed adaptation device. This has the advantage that the document of value is clamped at at least two positions located one after the other. The document of value is thus guided better while it is being transported, and skewing or a lateral deflection (run-up or run-down) of the document of value is avoided.

The small distance also allows the acceleration/deceleration to be carried out while the document of value is clamped at these two positions. The speed adaptation device, or the control device, can be adapted, for example, to start the change in the transport speed of the document of value by the at least one transport roller pair at a time at which the second document of value is (still) being transported by means of the preceding transport means.

Usually, during an acceleration of the documents of value relative to the preceding transport means, when the preceding transport means is still in engagement/frictional engagement with the documents of value, the frictional force of the preceding transport means would act against the acceleration of the document of value and mechanically stress the documents of value. In order to keep the mechanical stress low during acceleration, the preceding transport means can be configured to transport the documents of value unfixed, or with a low static friction, such that, while the documents of value are being transported by the preceding transport means, they can be accelerated relative to the preceding transport means, for example can be made to roll on or slide relative to the preceding transport means, without being damaged. For example, the preceding transport means is configured to transport the documents of value without holding them in respect of their relative movement relative to the preceding transport means. In order to transport the documents of value unfixed, or with such a low static friction, or without holding them,
the preceding transport means can comprise an integrated freewheel for higher transport speeds, for example one or more transport roller(s) or transport roller pair(s) provided with such a freewheel, or
the preceding transport means can transport the documents of value by means of a frictional force that is chosen to be so low that the documents of value can be accelerated relative to the preceding transport means, or can be made to slide relative to the preceding transport means, without being damaged.

In order to keep the mechanical stress low during acceleration/deceleration of the document of value even when the distance between the last point of engagement of the preceding transport means and the first point of engagement of the at least one transport roller pair of the speed adaptation device is smaller than the length of the documents of value, the preceding transport means-instead of transporting the documents of value unfixed-can also be accelerated/decelerated synchronously with the (first) transport roller pair of the speed adaptation device. Optionally, the at least one transport roller pair of the speed adaptation device can further accelerate the document of value even after it has left the engagement of the preceding transport means.

In preferred exemplary embodiments, the preceding transport means is driven by means of a drive (i.e. it actively transports the document of value and is not simply moved concomitantly by the document of value) and the distance between the last point of engagement of the preceding transport means and the first point of engagement (clamping point) of the at least one transport roller pair of the speed adaptation device is smaller than the length of the documents of value. In order to allow the document of value to be extracted without resistance from clamping by the preceding transport means during acceleration of the document of value by the speed adaptation device, the preceding transport means is equipped with an integrated freewheel for higher transport speeds.

In particular, the control device can be configured to control a start time, at which the path speed of the transport roller(s) (the first transport roller following the preceding transport means) of the transport roller pair is changed starting from the first transport speed, in dependence on a sensor signal transmitted by a sensor. The sensor, which can comprise, for example, one or more light barriers, is located in the region of the preceding transport means and/or at the transition between the preceding transport means and the at least one transport roller pair of the speed adaptation device. It is configured to register the document of value that is being transported past, for example the leading edge thereof, and to transmit to the control device a sensor signal corresponding to the time of registration. For example, the sensor is arranged between the last point of engagement of the preceding transport means and the first point of engagement, or the first clamping point, of the transport roller pair. It is thus able to register the leading edge of the document of value at a time before the document of value comes to be engaged by the transport roller pair. For example, the sensor is positioned at the transition, such that it registers the leading edge of the document of value just as the document of value leaves or has left the engagement of the preceding transport means.

Alternatively or in addition, the control device of the speed adaptation device can have information about the first transport speed of the preceding transport means and information about the second transport speed of the following transport means. For example, it can receive this information from another control device (e.g. of the preceding/following transport means) or determine it on the basis of the signals received from sensor devices (e.g. light barriers arranged along the preceding and following transport means). On the basis of this information about the first and second transport speeds, the control device can control the at least one transport roller drive of the at least one transport roller pair. For example, it can change the intensity of the acceleration/deceleration of the document of value in dependence on the difference between the first and second transport speeds. It can, for example, change the rotational speed that the transport roller pair (the first transport roller pair where there is a plurality of transport roller pairs) has on arrival of the document of value such that it corresponds to the first transport speed, and/or it can adapt the rotational speed that the transport roller pair (the last transport roller pair where there is a plurality of transport roller pairs) has on transfer of the document of value to the following transport means such that it corresponds to the second transport speed (i.e. the path speed of the (last) transport roller pair is equal to the first or second transport speed).

In the simplest case, the speed adaptation device comprises only one transport roller pair (no cascade of transport rollers) between the preceding and the following transport means, when viewed along the transport path. However, further transport rollers may optionally be used at the same position along the transport path, for example on the same shaft of the upper/lower transport roller of the transport roller pair. The control device is then configured to modulate the rotational speed of the transport rollers of the transport roller pair by means of the transport roller drive such that the path speed of the transport rollers is varied, for example periodically, between the first transport speed and the second transport speed of the documents of value.

In a development, the speed adaptation device comprises at least two transport roller pairs (e.g. a cascade of transport roller pairs) between the preceding and the following transport means, when viewed along the transport path, said transport roller pairs being arranged along the transport path between the preceding transport means and the following transport means and one behind the other along the transport path, and a plurality of transport roller drives for these transport roller pairs. The control device can be adapted to control the transport roller drives of these transport roller pairs such that the document of value is accelerated or decelerated from the first transport speed to the second transport speed by the rotation of the transport roller pairs. The advantage of a plurality of transport roller pairs is that greater speed changes are thus possible with a small space requirement, for example for more intense acceleration or deceleration operations.

The control device can be adapted to control the transport roller drives of the at least two transport roller pairs such that the change (acceleration/deceleration) of the document of value from the first transport speed to the second transport speed is carried out in at least two stages.

For example, the speed adaptation device has, along the transport path between the preceding transport means and the following transport means, at least one first transport roller pair and at least one second transport roller pair and also optionally further transport roller pairs, wherein the first and the second and optionally the further transport roller pairs are arranged one behind the other along the transport path. The control device can be configured to control the transport roller drives of the transport roller pairs such that, in a first stage, the document of value is brought (accelerated/decelerated) from the first transport speed to an intermediate transport speed with the aid of the first transport roller pair, and in one or more further stages is brought (accelerated/decelerated) from the intermediate transport speed to the second transport speed with the aid of the second and optionally the further transport roller pairs. The intermediate transport speed is between the first and second transport speeds.

For example, the control device can be configured to control the transport roller drives of the transport roller pairs such that the first transport roller pair receives the document of value from the preceding transport means at the first transport speed, accelerates/decelerates the document of value in a first stage to the intermediate transport speed and conveys it to the second transport roller pair, and such that, by means of the second transport roller pair, the document of value accelerated/decelerated to the intermediate transport speed by the first transport roller pair
is accelerated/decelerated further in a second stage to an even higher/lower intermediate transport speed and is conveyed to one or more further transport roller pairs, the transport roller drives of which are controlled by the control device such that they accelerate/decelerate the document of value (in one or more further stages) from the higher/lower intermediate transport speed of the second transport roller to the second transport speed, and convey it to the following transport means (R5), or
is accelerated/decelerated in a second stage to the second transport speed, and is conveyed at the second transport speed to the following transport means.

In order to obtain two accelerating/decelerating clamping points for the document of value, the distance between the transport roller pairs of the speed adaptation device along the transport path is chosen to be smaller than the length of the document of value. The risk of run-up/run-down/skewing during acceleration/deceleration of the document of value is thus reduced. For example, the rotational speeds of two of the transport roller pairs, which are arranged immediately one after the other, is then increased/reduced synchronously with one another while they are simultaneously in engagement with the document of value. For example, the first driven transport roller pair is actively accelerated/decelerated, by means of its motor, when the second driven transport roller pair accelerates/decelerates the document of value. Alternatively, for a possible acceleration, the first driven transport roller pair can be equipped with a freewheel for higher rotational speeds, so that it does not work against the acceleration force of the next driven transport roller pair.

The invention relates also to an apparatus for processing documents of value, said apparatus comprising a first apparatus module and a second apparatus module, which are arranged one after the other along the transport path of the documents of value, and comprises the above-described apparatus for transporting the documents of value. The first apparatus module provides the first transport speeds for the documents of value, and the second apparatus module provides the second transport speeds for the documents of value. The preceding transport means belongs to the first apparatus module, and the following transport means belongs to the second apparatus module. The second apparatus module is arranged downstream of the first apparatus module along the transport path of the documents of value.

The speed adaptation device is then configured to change the transport speed of a document of value that is being transported at the first transport speed in the first apparatus module from the first to the second transport speed of the second apparatus module with the aid of the at least one transport roller pair.

The at least one transport roller pair of the speed adaptation device can be arranged at the end of the first apparatus module or at the start of the second apparatus module, or it can be arranged between the first apparatus module and the second apparatus module, for example in a coupling module arranged between the first and second apparatus modules.

The first apparatus module can comprise a first module drive for driving the preceding transport means, and the second apparatus module can comprise a second module drive (which is preferably operated independently of the first module drive) for driving the following transport means. If such decentralized drives provide different transport speeds for the documents of value, the speed adaptation device can advantageously be used to make possible a gentle transition between these transport speeds for the document of value.

The second apparatus module can be part of the same document of value processing apparatus as the first apparatus module, or can be part of a different document of value processing apparatus that is located downstream of the document of value processing apparatus of the first apparatus module along the transport path of the documents of value. In the second case, the first apparatus module, which belongs to a first document of value processing apparatus, can be arranged along the transport path of the documents of value at the end of the first document of value processing apparatus, and the second apparatus module, which belongs to a second document of value processing apparatus, can be arranged along the transport path of the documents of value at the start of the second document of value processing apparatus. Accordingly, the above-mentioned coupling module can be arranged between and optionally connect the first apparatus module of the first document of value processing apparatus and the second apparatus module of the second document of value processing apparatus.

The invention relates also to a method for transporting documents of value, in particular with the aid of the apparatus described above. In the method, the documents of value are transported individually one after the other along a transport path of the documents of value with the aid of a transport device, in particular by means of the transport device described above. The document of value is transported with the aid of at least one preceding transport means, at a first transport speed, to a speed adaptation device, which comprises at least one transport roller pair. The speed adaptation device changes a transport speed of the document of value, with the aid of the at least one transport roller pair, from the first transport speed to a second transport speed of a following transport means, said second transport speed being different from the first transport speed. The document of value is then transported further along the transport path at the second transport speed with the aid of the following transport means. In particular, the documents of value are transported to the speed adaptation device individually one after the other.

The features and advantages described in relation to the apparatuses according to the invention and in relation to the speed adaptation device apply correspondingly to the method according to the invention. Further features of the invention will become apparent from the claims, the figures and the description of the figures.

The invention will be explained in greater detail hereinbelow with reference to figures, in which:

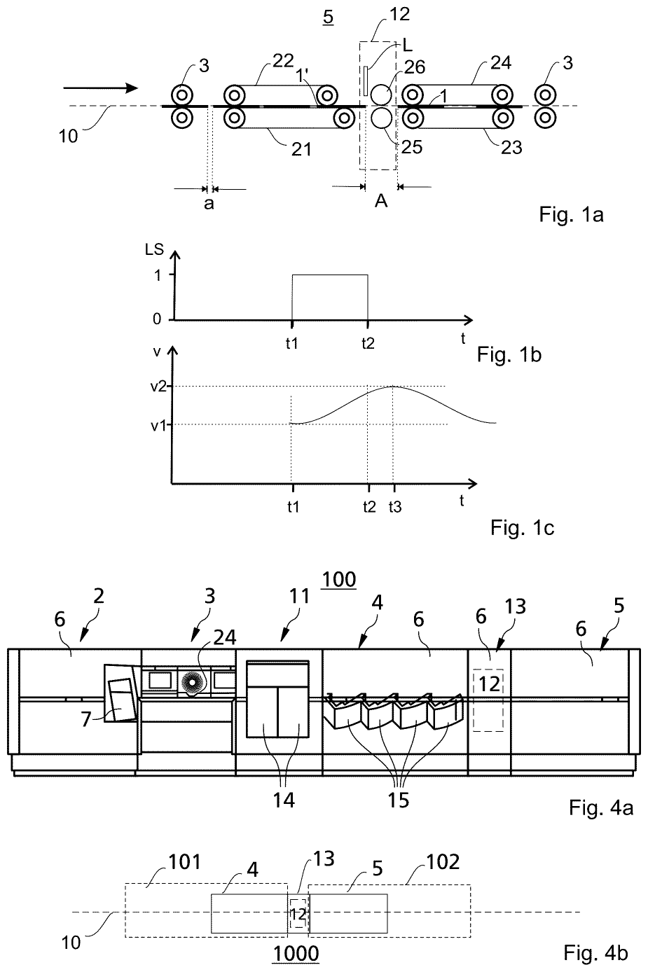

FIG. 1 a, b, c show a first exemplary embodiment of an apparatus for transporting documents of value having a speed adaptation device, a light barrier signal (FIG. 1b), and a temporal profile of the modulated rotational speed (FIG. 1c),

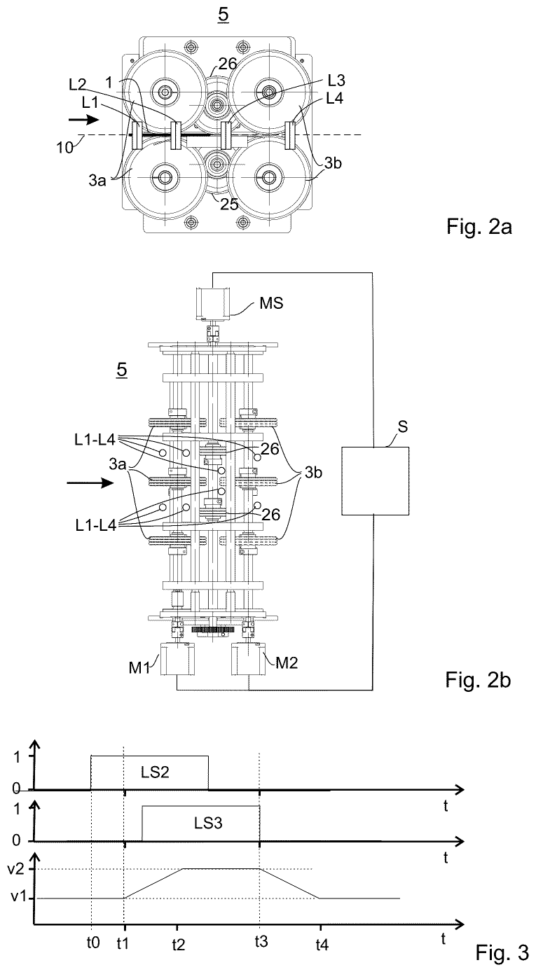

FIG. 2 a, b show a second exemplary embodiment of an apparatus for transporting documents of value having a speed adaptation device,

FIG. 3 shows a light barrier signal LS and the temporal profile of the modulated rotational speed in the case of the second exemplary embodiment,

FIG. 4a shows a document of value processing apparatus having a plurality of apparatus modules and a coupling module having a speed adaptation device,

FIG. 4b shows two document of value processing apparatuses with a speed adaptation device interposed between them,

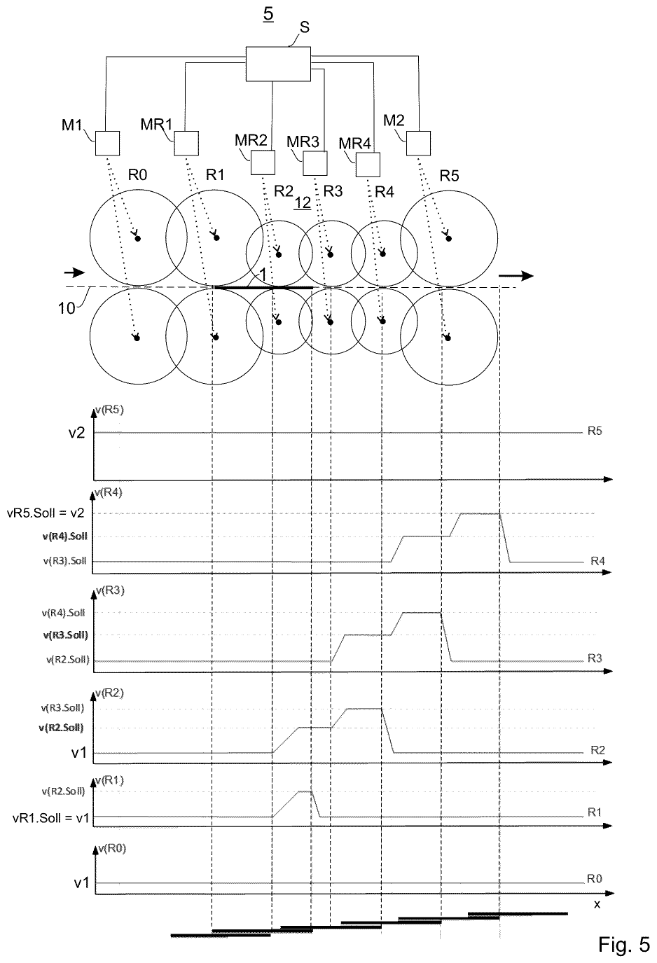

FIG. 5 shows a third exemplary embodiment of an apparatus for transporting documents of value having a speed adaptation device (top) and modulated rotational speeds of the transport roller pairs (bottom).

FIG. 1a shows a transport apparatus 5 by means of which documents of value 1 are transported along a transport path 10. The transport apparatus 5 comprises a plurality of transport rollers 3, which are located opposite one another, and opposite transport belts 21, 22 and 23, 24, which run around rollers and between which the documents of value are clamped and transported. A speed adaptation device 12 is arranged along the transport path 10 between the transport belts 21, 22 and 23, 24, said speed adaptation device comprising a rotatable, driven transport roller pair having two mutually opposite transport rollers 25, 26. The two preceding transport belts 21, 22 run at a first transport speed v1, and the two following transport belts 23, 24 run at a second, higher transport speed v2. The transport speed v of the document of value 1 is adapted from v1 to v2 while the document of value is being transported through, or past, the speed adaptation device 12.

In the example of FIG. 1, the transport speed v2 is greater than v1, and the speed adaptation device 12 carries out an acceleration of the documents of value from v1 to v2. The distance between the documents of value is thus increased from a first distance a to a greater, second distance A. Alternatively, however, v2 could also be lower than v1, and the speed adaptation device 12 could carry out a deceleration of the documents of value and a reduction of the distance. Alternatively or in addition, the speed adaptation device 12 could also carry out a variable distance adaptation, in which-depending on the aim of the adaptation-the document of value is accelerated or decelerated more or less strongly.

At the transition between the slower transport belt pair 21, 22 and the faster transport belt pair 23, 24, the documents of value 1 are gripped by frictional engagement by the mechanical engagement of the transport roller pair 25, 26 of the speed adaptation device 12 and accelerated or decelerated constantly and transported further at the higher/lower transport speed of the transport belt pair 23, 24. The transport belt 21 is shorter than the transport belt 22 and transports the documents of value with such low friction that the documents of value are able to slide relative to the transport belt 21 without being damaged when they are accelerated by the transport roller pair 25, 26.

FIG. 1b shows the light barrier signal LS of a light barrier L, see FIG. 1a, and FIG. 1c shows the temporal profile of the path speed of the accelerating transport roller pair 25, 26, said path speed being modulated between v1 and v2.

When the leading edge of the document of value is registered by the light barrier L at time t1, the rotational speed of the transport rollers 25, 26 is slowly increased. Shortly after time t, the document of value 1 becomes clamped between the two transport rollers 25, 26 and is thus accelerated continuously from the first path speed v1 to the second path speed v2. The first path speed v1 of the transport roller 26 corresponds, for example, to the transport speed of the transport belt pair 21, 22, which transports the document of value 1 to the transport rollers 25, 26, and the second path speed v2 of the transport roller 26 corresponds, for example, to the transport speed of the transport belt pair 23, 24, which transports the documents of value 1 further after the transport roller pair 25, 26. Since the document of value is still being clamped by the transport rollers 25, 26 at time t2 at which the light barrier L registers the back edge of the document of value, the rotational speed of the transport rollers 25, 26 is reduced again only with a time offset, at a later time t3, when the document of value 1 has definitely been transported out of clamping by the transport roller pair 25, 26.

FIG. 2 a, b show a second exemplary embodiment of the transport apparatus 5. FIG. 2a shows the speed adaptation device 12 in a side view, and FIG. 2b shows it in a top view of the transport plane of the documents of value 1. The arrow in each case indicates the transport direction of the documents of value 1 along the transport path 10. The temporal profile of the light barrier signal LS is shown in FIG. 3 at the top, and the temporal profile of the path speed v of the accelerating transport roller pair 25, 26 is shown in FIG. 3 at the bottom.

Along the transport path 10 of the documents of value there are arranged one after the other a first transport roller pair 3a, an accelerating/decelerating transport roller pair 25, 26 of the speed adaptation device 12, and a second transport roller pair 3b, said transport roller pairs having different transport speeds. The first transport roller pair 3a is driven by a motor M1 at a low rotational speed, which corresponds to a low transport speed v1 of the documents of value, see FIG. 3. The third transport roller pair 3b is driven by a motor M2 at a higher rotational speed, which corresponds to a higher transport speed v2 of the documents of value. Alternatively, the first transport roller pair 3a and/or the third transport roller pair 3b can also be driven by the drive of a further transport means preceding the first transport roller pair 3a or by a further transport means following the third transport roller pair 3b, so that it does not require its own motor M1 or M2. Alternatively, the motor M2 can drive not only the third transport roller pair 3b but, with a fixed speed increase/reduction, also the first transport roller pair 3a.

In order to prevent the documents of value from twisting as they are being accelerated, a further transport roller 25 is arranged on the shaft of the transport roller 25, and a further transport roller 26 is arranged on the shaft of the transport roller 26, which further transport rollers can be identical with the transport rollers 25 and 26, are driven in phase therewith and are used to accelerate the documents of value, see FIG. 2b.

One or both transport rollers of the transport roller pair 25, 26 of the speed adaptation device 12 are driven by means of a step motor MS, which drives said roller, until the arrival of a document of value 1, firstly at the rotational speed corresponding to the lower transport speed v1 of the first transport roller pair 3a, see FIG. 3. Modulation of the rotational speed of the transport rollers 25, 26 is produced by varying the motor speed of the step motor MS, said motor speed being controlled by a control device S.

Although the transport rollers 3a are driven, they may be equipped with an integrated freewheel for higher rotational speeds, said freewheel allowing the document of value to be extracted without resistance from clamping by said transport rollers, for example when the transport roller pair 25, 26 of the speed adaptation device 12 carries out an acceleration of the document of value. The motor M1 can also be used to reduce the transport rollers 3a from the higher rotational speeds back to the starting speed again. Otherwise, on arrival of the next document of value, the transport rollers 3a, owing to their inertia, could rotate with a higher rotational speed than the first transport speed and decelerate as a result of undesirable friction against the following document of value.

When viewed along the transport path, four light barrier pairs L1-L4 are arranged in FIGS. 2a and 2b, said light barrier pairs registering the leading and/or back edge of the documents of value and transmitting the corresponding registration time to the control device S. A first optional light barrier pair L1, which is located in the left-hand portion of the transport rollers 3a, registers the arriving leading edge of the document of value in order to signal the arrival of the document of value. The second light barrier pair L2, which is located at the end of the transport rollers 3a but before the transport roller pair 25, 26 of the speed adaptation device 12, registers the arrival of the leading edge of the document of value 1 at time to and reports this to the control device S of the distance increasing device 12 (light beam signal LS2, see FIG. 3). Triggered by the leading edge signal reported by the light barrier pair L2 at time to, the control device S controls the motor MS of the transport roller pair 25, 26 such that the rotational speed of the transport rollers 25, 26 is increased from a time t1 shortly thereafter, in order to increase the path speed of the transport rollers 25, 26, starting from the lower first transport speed v1 at time t1, to the higher, second transport speed v2 at time t2, see FIG. 3. The document of value is thus accelerated smoothly and continuously from the first transport speed v1 of the transport roller pair 3a to the second transport speed v2 of the transport roller pair 3b. The transport roller pair 3b transports the document of value further at the higher, second transport speed v2. With the aid of the light barrier pair L4 arranged in the region of the transport roller pair 3b, it is possible to check whether the desired speed adaptation has successfully been carried out for the document of value in question.

If the light barrier L3 then reports to the control device, at time t3, that it has registered the rear edge of the document of value 1 (light barrier signal LS3), the control device causes the transport roller drive of the transport roller pair 25, 26, in response thereto, to reduce the rotational speed of the transport rollers 25, 26 again from time t3, specifically such that the path speed of the transport roller pair 25, 26 is reduced from the second transport speed v2 back to the first transport speed v1 again, see FIG. 3. This takes place until time t4, which lies within the time interval that exists until the arrival of the next document of value 1′, in order that the next document of value 1′ can be gripped by the transport rollers 25, 26 with the first transport speed v1 again. Optionally, the registration times of the next document of value that are determined by the light barrier pairs L1 and/or L2 can be used to make the deceleration behavior of the transport roller pair 25, 26 such that the first transport speed is reached before the next document of value becomes clamped thereby.

Instead of a ramp-shaped profile of the angular or path speed of the transport rollers 25, 26, said speed can also be modulated by means of a sinusoidal or similar profile. In order to accelerate the document of value more quickly to the transport speed v2, the acceleration ramp can also be chosen to be shorter. Deceleration of the transport rollers to the transport speed v1 could thus also take place at an earlier time, for example in order to make said rollers ready to receive the next document of value more quickly.

Alternatively, however, v2 could also be smaller than v1, and the speed adaptation device 12 could carry out a deceleration of the documents of value and a distance reduction.

Alternatively or in addition, the speed adaptation device 12 could also carry out a variable distance adaptation, in which-depending on the aim of the adaptation-the document of value is accelerated or decelerated more or less strongly.

FIG. 4a shows a document of value processing apparatus 100, which is composed of different processing zones, which are embodied by the modules 2, 3, 4, 5 and also 11 and 13. The document of value processing apparatus 100 comprises an entry module 2, an operating module 3, a delivery module 4, an additional delivery module 11, a coupling module 13, and a shredder module 5, which are closed by covers 6.

Documents of value which are to be processed by the document of value processing apparatus 100 are placed into the entry module 2 arranged on the left next to the operating module 3. To this end, the entry module 2 comprises an entry compartment 7, which receives a stack of documents of value. The documents of value are then singled by a singler and checked, for example for authenticity and/or for their denomination and/or for their fitness for circulation, by a measuring system in the form of a measuring section having test sensors.

The entry module 2 is followed by the operating module 3, in which there is accommodated a reject compartment 24 into which there are destacked documents of value that have been rejected on account of the measurements in the entry module 2, for example documents of value that have been identified as counterfeit or documents of value that could not clearly be identified by the test sensors in the entry module 2. The remaining documents of value are transported further along the transport path in the document of value processing apparatus 100 to the delivery module 4, where they are delivered in bundled or stacked form. To this end, the delivery module 4 comprises a plurality of stackers, optionally banding units and also document of value delivery compartments 15. The optional additional delivery module 11 increases the delivery volume of the document of value processing apparatus and to this end comprises two delivery stackers 14 without banding units, in which larger quantities of documents of value can be delivered in loosely stacked form. In the final shredder module 5, documents of value that have been identified as not fit for circulation, that is to say, for example, damaged or heavily soiled documents of value, can be destroyed and then delivered to a secure compartment for disposal.

The coupling module 13, which connects the delivery module 4 and the shredder module 5, contains a speed adaptation device 12, in order to change the transport speed of the documents of value along the transport path from the transport speed of the delivery module 4 to the lower or higher transport speed of the shredder module 5. By means of the speed adaptation device 12 installed between the modules, different transport speeds can then be achieved in the modules, or synchronization fluctuations of the drives of the individual modules can be equalized.

Alternatively or in addition, one or more speed adaptation devices 12 can also be provided between the other modules 2, 3, 11 and 4, said speed adaptation devices adapting the transport speed of the documents of value along the transport path from the transport speed of the preceding module to the transport speed of the following module. This is advantageous specifically when decentralized drives for the different modules are used in the document of value processing apparatus 100.

FIG. 4b shows an apparatus 1000 having two document of value processing apparatuses 101 and 102, which are arranged one after the other along the transport path 10 of the documents of value. The first document of value processing apparatus 101 comprises a first apparatus module 4, and the second document of value processing apparatus 102 comprises a second apparatus module 5. Between the two apparatus modules 4 and 5 there is a coupling module 13 having one or more speed adaptation devices 12, which accelerate or decelerate the document of value from the first transport speed v1 of the first document of value processing apparatus 101 to the second transport speed v2 of the second document of value processing apparatus 102.

FIG. 5 shows a third exemplary embodiment of an apparatus for transporting documents of value having a speed adaptation device 12, which comprises four driven transport roller pairs R1-R4 arranged one behind the other along the transport path 10. The preceding transport roller pair R0 transports the documents of value 1 at the first transport speed v1 to the speed adaptation device 12, and the following transport roller pair R5 transports the documents of value 1 coming from the speed adaptation device 12 further at the second transport speed v2. The rotational speeds of the transport roller pairs RO and R5 are constant. In the case of the transport roller pairs R1-R4 of the speed adaptation device 12, the rotational speeds are modulated.

A control device S of the speed adaptation device 12 controls the transport roller drives MR1-MR4 of the four transport roller pairs R1-R4 such that the acceleration of the document of value from the first transport speed v1 to the second transport speed v2 is carried out in four separate stages.

In the speed diagrams at the bottom of FIG. 5, the distance x traveled by the leading edge of the document of value is shown on the x-axis, and the path speeds v(R0), v(R1), v(R2), v(R3), v(R4) and v(R5) of the transport roller pairs R0-R5 when the leading edge of the document of value passes the transport roller in question are shown on the y-axis. For illustration purposes, the associated position of the document of value along the transport path 10 is shown beneath the diagram v(R0).

The rotational speed of the transport roller pair R1 has a target rotational speed v(R1.Soll)=v1. The instantaneous rotational speed of the transport roller pair R1 varies in the profile and is increased from its own target rotational speed v(R1.Soll) to the target rotational speed of the following roller v(R2.Soll) as soon as the leading edge of the document of value becomes clamped by the following transport roller pair R2, see diagram v(R1).

The rotational speeds of the transport roller pairs R2-R4 have a target rotational speed v(Rn. Soll), wherein n=2, 3, 4. The instantaneous rotational speed of the transport roller R1-R4 varies in the profile
between the target rotational speed v(Rn−1.Soll) of the previous transport roller,
its own target rotational speed v(Rn.Soll) and
the target rotational speed of the following roller v(Rx+1.Soll),
   where:
v(Rn)<v(Rn. Soll) or v(Rn)=v(Rn−1.Soll), until the leading edge of the bank note becomes clamped by the transport roller pair Rn,
acceleration of v(Rn) from v(Rn−1.Soll) to the own target rotational speed v(Rn.Soll),
transport of the document of value at the target rotational speed v(Rn.Soll) until subsequent clamping by the transport roller pair Rn+1,
further acceleration from v(Rn.Soll) to v(Rn+1.Soll) as soon as the leading edge of the document of value becomes clamped by the following transport roller pair Rn+1.

After the acceleration, the document of value follows the speed of the transport roller pair Rn+1 until the rear edge has moved out of clamping by the transport roller pair Rn. The transport roller pair Rn is then slowed to the rotational speed v(Rn)=v(Rn−1.Soll) for the next document of value (n=1-4).

In order to achieve that the transport roller pair Rn (n=1-4) follows the rotational speed of the following transport roller pair Rn+1 (which is greater than the target rotational speed v(Rn.Soll)), the rotation of the transport roller pair Rn is accelerated actively and synchronously with the motor speed of the transport rollers Rn+1. Alternatively, the transport roller pair Rn can be equipped with a freewheel for higher rotational speeds.

In order to obtain two accelerating clamping points for the document of value, the distance between the transport roller pairs R1 and R2 and R2 and R3 and R3 and R4 along the transport path is chosen to be smaller than the length of the document of value. The risk of run-up/run-down/skewing of the document of value is thus reduced, that is to say the risk that the document of value will adopt a skewed position or will acquire an offset laterally to the right or left as it is accelerated is reduced.

1.-15. (canceled)

16. An apparatus for transporting documents of value, having a transport device, which is configured to transport the documents of value individually one after the other along a transport path and which comprises along the transport path at least one preceding transport means, which provides a first transport speed for the documents of value transported thereby, and at least one following transport means, which provides a second transport speed for the documents of value transported thereby, said second transport speed being different from the first transport speed,
wherein the apparatus comprises a speed adaptation device having at least one transport roller pai, which is arranged along the transport path between the preceding and the following transport means, and
in that the speed adaptation device is configured to change a transport speed of a document of value transported at the first transport speed to the speed adaptation device from the first transport speed to the second transport speed with the aid of the at least one transport roller pair, by changing a rotational speed of at least one transport roller of the at least one transport roller pair.

17. The apparatus according to claim 16, wherein the speed adaptation device comprises at least one transport roller drive for the at least one transport roller pair, and a control device for controlling the at least one transport roller drive, said control device being adapted to control the at least one transport roller drive such that it rotates at least one, preferably both, of the transport rollers of the at least one transport roller pair with a changeable rotational speed, with a modulated rotational speed.

18. The apparatus according to claim 17, wherein the control device is adapted to change, to modulate, the rotational speed of at least one transport roller of the at least one transport roller pair, with the aid of the at least one transport roller drive of the at least one transport roller pair, such that the transport speed of the respective document of value is changed by the action of the at least one transport roller rotating with a modulated rotational speed from the first transport speed to the second transport speed.

19. The apparatus according to claim 17, wherein the control device is configured to drive one or both of the transport rollers of the at least one transport roller pair by means of the at least one transport roller drive such that the at least one transport roller pair changes the transport speed of the respective document of value continuously from the first transport speed to the second transport speed.

20. The apparatus according to claim 16, wherein, in the region of the preceding transport means and/or at the transition between the preceding transport means and the at least one transport roller pair of the speed adaptation device, there is arranged at least one sensor, which is configured to register the document of value that is transported past and to transmit a sensor signal corresponding to the time of registration to the control device,
wherein the control device is configured to control a start time, at which a path speed of the respective transport roller(s) of the transport roller pair is changed starting from the first transport speed, in dependence on the sensor signal transmitted by the sensor.

21. The apparatus according to claim 16, wherein the control device of the speed adaptation device has information about the first transport speed of the preceding transport means and information about the second transport speed of the following transport means and controls the at least one transport roller drive of the at least one transport roller pair, the change of the rotational speed of at least one transport roller of the at least one transport roller pair, on the basis of this information.

22. The apparatus according to claim 16, wherein
the distance between a last point of engagement of the at least one transport roller pair and a first point of engagement of the following transport means is smaller than the length of the documents of value, and/or
the distance between a last point of engagement of the preceding transport means and a first point of engagement of the at least one transport roller pair along the transport path is smaller than the length of the documents of value,
wherein the preceding transport means is preferably equipped with an integrated freewheel.

23. The apparatus according to claim 16, wherein the speed adaptation device comprises only one transport roller pair between the preceding and the following transport means, as viewed along the transport path, and in that the control device is configured to modulate the rotational speed of at least one of the transport rollers of the transport roller pair by means of the transport roller drive such that the path speed of the at least one transport roller is varied, periodically, between the first transport speed and the second transport speed of the documents of value.

24. The apparatus according to claim 16, wherein the speed adaptation device comprises at least two transport roller pairs, which are arranged along the transport path between the preceding transport means and the following transport means and one behind the other along the transport path, and comprises a plurality of transport roller drives for these transport roller pairs,
wherein the control device is adapted to control the transport roller drives of the transport roller pairs such that the respective document of value is brought, accelerated or decelerated, from the first transport speed to the second transport speed by the rotation of the transport roller pairs.

25. The apparatus according to claim 24, wherein the speed adaptation device comprises, along the transport path between the preceding transport means and the following transport means, at least one first transport roller pair and at least one second transport roller pair and also optionally further transport roller pairs,
wherein the first and the second and optionally the further transport roller pairs are arranged one after the other along the transport path, and
wherein the control device is configured to control the transport roller drives of the transport roller pairs such that the document of value is brought, accelerated/decelerated, in a first stage from the first transport speed to an intermediate transport speed with the aid of the first transport roller pair, and in one or more further stages is brought, accelerated/decelerated, from the intermediate transport speed to the second transport speed with the aid of the second and optionally the further transport roller pairs.

26. The apparatus according to claim 24, wherein the transport roller pairs of the speed adaptation device are at a respective distance from one another along the transport path that is smaller than the length of the documents of value.

27. An apparatus for processing documents of value, which
comprises the apparatus for transporting the documents of value according to claim, and
comprises a first apparatus module and a second apparatus module, which are arranged one behind the other along the transport path of the documents of value,
wherein the preceding transport means belongs to the first apparatus module and the following transport means belongs to the second apparatus module,
wherein the first apparatus module comprises a first module drive for driving the preceding transport means, and the second apparatus module comprises a second module drive for driving the following transport means.

28. The apparatus according to claim 27, wherein the second apparatus module is part of the same document of value processing apparatus as the first apparatus module, or in that the second apparatus module is part of a different document of value processing apparatus, which is located downstream, along the transport path of the documents of value, of the document of value processing apparatus of the first apparatus module.

29. The apparatus according to claim 27, wherein the at least one transport roller pair of the speed adaptation device is arranged at the end of the first apparatus module or at the start of the second apparatus module or is arranged between the first apparatus module and the second apparatus module.

30. A method for transporting documents of value, with the aid of the apparatus according to claim 16,
wherein the documents of value are transported individually one after the other along a transport path with the aid of a transport device, wherein
the documents of value are transported with the aid of at least one preceding transport means, at a first transport speed, to a speed adaptation device, which comprises at least one transport roller pair, and
the speed adaptation device changes a transport speed of the respective document of value, with the aid of the at least one transport roller pair, from the first transport speed to a second transport speed of a following transport means, said second transport speed being different from the first transport speed, and
the respective document of value is transported further along the transport path at the second transport speed with the aid of the following transport means.
